(19) United States
(12) Patent Application Publication
(10) Pub. No.: US 2022/0322713 A1
(43) Pub. Date: Oct. 13, 2022

(54) INSTANT VEGAN MEAT ANALOG GRANULATED POWDER AND METHODS OF MAKING SAME

(71) Applicant: MIXOY ISRAEL (M.I.) LTD., Ma'ale Efraim (IL)

(72) Inventor: Amiel DAVID, Ma'ale Efraim (IL)

(73) Assignee: MIXOY ISRAEL (M.I.) LTD., Ma'ale Efraim (IL)

(21) Appl. No.: 17/495,965

(22) Filed: Oct. 7, 2021

(30) Foreign Application Priority Data
Apr. 13, 2021 (IL) 282327

(51) Int. Cl. A23L 11/00; A23L 27/10; A23L 27/00

(52) U.S. Cl. CPC A23L 11/05; A23L 27/105; A23L 27/88

(57) ABSTRACT

Disclosed herein is an instant vegan meat analog granulated powder comprising: 10-50 wt.% legume protein flakes having particle size of 1-10 millimeters; 10-50 wt.% granulated fine legume protein having particle size of 0.05-0.3 millimeters; 5-20 wt.% legume flour (e.g., functional legume flour) having a particle size of at most 300 microns; and 1.5-25 wt.% nonhydrogenated vegetable oil. In some embodiments, the oil may at least partially cover particles comprising the legume protein flakes, the granulated fine legume protein and the legume flour.

### CROSS REFERENCE TO RELATED APPLICATIONS

This application claims the benefit of priority of IL Patent Application No. 282327, filed Apr. 13, 2021, the contents of which are all incorporated herein by reference in their entirety.

### FIELD OF THE INVENTION

The present invention relates to a vegan analog product. More particularly, the present invention relates to an instant vegan analog powder.

### BACKGROUND OF THE INVENTION

Meat analogs, for example, beef, lamb, pork, chicken vegan substitute products become very popular in recent years. Due to nutritive benefits, moral issues and environmental considerations, the meat analog markets are one of the most growing food markets in the last decade.

Most of the known meat analog products contain legumes as a source for protein mixed with stabilizers, pigments and flavors. The stabilizers are added in order to form the “meat-like” texture and the pigments and flavors to form the requested appearance and taste. Instant powders or flaks for producing meat analogs provide limited final product, having poor meat-like texture and therefore are not very popular. Most of the meat analogs products are ready-to-eat/cook frozen or chilled products, such as, sausages, “meat balls”, substitute “minced meat” and the like. Currently, there are no meat analogs that do not contain stabilizers and/or hydrogenated vegetable oil or naturally saturated oils, such as, palm hydrogenated oil. As known in the art, hydrogenated vegetable oil is unhealthy and stabilizers like methyl cellulose and modified starches, which are also unhealthy and additionally highly hygroscopic and therefore are less suitable to be added to a dry instant powder/flaks.

Accordingly, there is a need for easy-to-use instant vegan meat analogs powder, free of any stabilizers, for producing beef, lamb, pork, chicken, and fish, etc., analogs having meat-like texture.

### SUMMARY OF THE INVENTION

Some aspects of the invention may be directed to an instant vegan meat analog granulated powder comprising: 10-50 wt.% legume protein flakes having particle size of 1-10 millimeters; 10-50 wt.% granulated fine legume protein having particle size of 0.05- 0.3 millimeters; 5-20 wt.% legume flour (e.g., functional legume flour) having a particle size of at most 300 microns; and 1.5-25 wt.% nonhydrogenated vegetable oil. In some embodiments, the oil may at least partially cover particles comprising the legume protein flakes, the granulated fine legume protein and the legume flour.

In some embodiments, the instant vegan meat analog granulated powder may further include 3-15% edible fibers. In some embodiments, the instant vegan meat analog granulated powder may have a particle size of 0.2-20 millimeters. In some embodiments, the legume is pea. In some embodiments, the legume is selected from, chickpeas, beans, soybeans, pea, lentil, lupins, and a combination thereof

In some embodiments, the instant vegan meat analog granulated powder may further include additives. In some embodiments, the additives are selected from taste additives and color pigments.

In some embodiments, the granulated powder is for beef analog and the additives are one or more of: beat concentrate, fried onion, yeast extract, cocoa, caramel, salt, BBQ flavor, beef and umami flavors. In some embodiments, 40-60 wt.% water may be added to the beef analog granulated powder to form a beef analog.

In some embodiments, the granulated powder is for pork analog and the additives are one or more of: fried onion, yeast extract, cocoa, caramel, salt, BBQ flavor, pork flavor and umami flavors. In some embodiments, 40-60 wt.% water may be added to the pork analog granulated powder to form a pork analog.

In some embodiments, the granulated powder is for lamb analog and the additives are one or more of: beat concentrate, fried onion, yeast extract, cocoa, caramel, salt, BBQ flavor, lamb flavor and umami flavors. In some embodiments, 40-60 wt.% water may be added to the lamb analog granulated powder to form a lamb analog.

In some embodiments, the granulated powder is for chicken analog and the additives are one or more of: chicken flavor, fried onion, yeast extract, umami flavor and salt. In some embodiments, 40-60 wt.% water may be added to the chicken analog granulated powder to form a chicken analog.

In some embodiments, the granulated powder is for fish analog and the additives are one or more of: fish flavor, fried onion, yeast extract, umami flavor and salt. In some embodiments, 40-60 wt.% water may be added to the fish analog granulated powder to form a fish analog.

Some aspects of the invention may be directed to a method of making vegan meat analog granulated powder comprising: mixing together in a mixer to form a mix: 10-50 wt.% legume protein flakes having particle size of 1-10 millimeters; 10-50 wt.% granulated fine legume protein having particle size of 0.05-0.3 millimeters; and 5-20 wt.% legume flour (e.g., functional legume flour) having a particle size of at most 300 microns; and adding to the mix 1.5-25 wt.% nonhydrogenated vegetable oil such that the oil at least partially covers particles comprising the legume protein flakes, the granulated fine legume protein and the legume flour resulting in agglomeration of the powder particles.

In some embodiments, adding the oil may be conducted by one of: manual spray bottle, a fluid bed coating machine, spray coating machine and a coating tumble drum.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a flowchart of a method of making vegan meat analog granulated powder, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The current invention relates to an instant vegan meat analog, also known as, vegan meat substitute in the form of dry instant granulated powder. In some embodiments, the vegan meat analog granular powder may be mixed with water or other water-based liquids (e.g., wine, broth) for producing a final “meat-like” product. In some embodiments, the instant granulated powder may be free of any stabilizers, while still providing the required texture.

An instant vegan meat analog granulated powder, according to some embodiments of the invention, may include granulated powder particles each being at least partially coated with nonhydrogenated vegetable oil. Each one of the coated particles may continue legume protein flakes, granulated fine legume protein and legume flour (e.g., functional or nonfunctional flour). In some embodiments, it was found that coating this specific combination of legume-based powder produces a granulated powder that upon the addition of water may form a meat-like (e.g., minced meat) texture, free of any stabilizers or hydrogenated or high in saturated fatty acids vegetable oil.

As used herein legume flour may be defined as finely grided legumes having a particle size of at most 300 microns. In some embodiments, the legume flour may be a chickpeas flour, a beans flour, a soybeans flour, a pea flour, a lentils flour, a lupins flour, and a combination thereof

As used herein functional legume flour may be defined as a flour from native legumes physically, enzymatically, or chemically treated to change its properties, for example, micro-grinded legume (e.g., pea) made by extrusion cooking. Other optional methods for making functional legume flour may include, washing steps during processing ,different drying methods that improve functionality, aggregation and also coating with emulsifiers, micro-particulation (physical process), chemical alteration and the like. In some embodiments, the functional legume flour may be micro-grinded pea made by extrusion cooking.

In some embodiments, the vegan meat analog granulated powder may include: 10- 50 wt.% legume protein flakes (e.g., coarse granulated legume protein) having particle size of 1-10 millimeters: 10-50 wt.% granulated fine legume protein having particle size of 0.05-0.3 millimeters, 5-20 wt.% legume flour (e.g., functional legume flour) having a particle size of at most 300 microns; and 1.5-25 wt.% nonhydrogenated vegetable oil. In some embodiments, the nonhydrogenated vegetable oil may at least partially cover particles including the legume protein flakes, the granulated fine legume protein and the legume flour. In some embodiments, each one of the particles may further include edible fibers. In some embodiments, the vegan meat analog granulated powder may include 3-15% edible fibers.

In some embodiments, the legume protein flakes may be coarse granulated legume protein may have particle size of: 1-3 millimeters, 2-5 millimeters, 3-7 millimeters, 4-8 millimeters and 2-8 millimeters. In some embodiments, the granulated fine legume protein may have particle size of: 0.05-0.1 millimeters, 0.08-0.2 millimeters, 0.1-0.3 millimeters and 0.1-0.2 millimeters.

In some embodiments, a functional legume flour, for example, functional pea flour may act a stabilizer.

In some embodiments, the final product particles may have particle (e.g., flaks) size of 2-20 millimeters.

In some embodiments, the final product may be substantially dry (e.g., having less than 15 wt.% humidity) therefore may have long shelf-life, for example, 12 months in the original closed package.

In some embodiments, several different legume proteins and different legume flours may be used. For example, the source for the protein flakes and/or the granulated fine legume protein may be: pea protein, chickpea protein, beans protein, soybeans protein, lentil protein, lupins protein, and a combination thereof In some embodiments, the source for legume flour (e.g., functional legume flour) may be chickpeas flour, beans flour, soybeans flour, pea flour, lentils flour, lupins flour, and a combination thereof. In some embodiments, although legumes, such as, soybeans and beans produce are fairly good products, it was found that the best final texture (e.g., meat-like texture) is received when using pea protein and pea flower. In some embodiments, the pea-based meat analog granulated powder may be nonallergenic, due the absence of any soybeans or other allergenic raw materials.

In some embodiments, the nonhydrogenated vegetable oil may be any nonhydrogenated edible vegetable oil, for example, canola oil, sunflower oil, olive oil, soybeans oil and the like.

In some embodiments, the meat analog granulated powder may include additives, excluding any stabilizers. In some embodiments, the additives may be selected from taste additives and color pigments. For example, for producing beef substitute/analog granulated powder the additives may be selected from: beat concentrate, fried onion, yeast extract, cocoa, caramel, salt, BBQ flavor, beef and umami flavors. In another example, for producing pork substitute/analog granulated powder the additives may be selected from: fried onion, yeast extract, cocoa, caramel, salt, BBQ flavor, pork flavor, umami flavor and the like. In yet another example, for producing lamb analog granulated powder the additives may be selected from: beat concentrate, fried onion, yeast extract, cocoa, caramel, salt, BBQ flavor, lamb flavor, umami flavors and the like. In yet another example, for producing chicken analog granulated powder the additives may be selected from: chicken flavor, fried onion, yeast extract, umami flavor, salt and the like. In yet another example, for producing fish analog granulated powder the additives may be selected from: fish flavor, fried onion, yeast extract, umami flavor, salt and the like.

In some embodiments, water or water-based liquids may be added to the meat analog granulated powder, for example, at room temperature. When adding the water and simply manually or mechanically mixing the powder with the water a meat-like texture may be obtained. For example, mixing 40-60 wt.% of water or water-based liquid (e.g., red wine, broth, bear, etc.) with the beef analog granulated powder may form a minced beef texture, suitable for cooking, Bolognese source, meat balls and the like. In another example, mixing 40-60 wt.% of water or water-based liquid (e.g., rose wine) with the pork analog granulated powder may form a minced pork texture. In another example, mixing 40-60 wt.% of water or water-based liquid (e.g., red wine, bear, etc.) with the lamb analog granulated powder may form a minced lamb texture. In another example, mixing 40-60 wt.% of water or water-based liquid (e.g., white wine) with the chicken analog granulated powder may form a minced chicken texture.

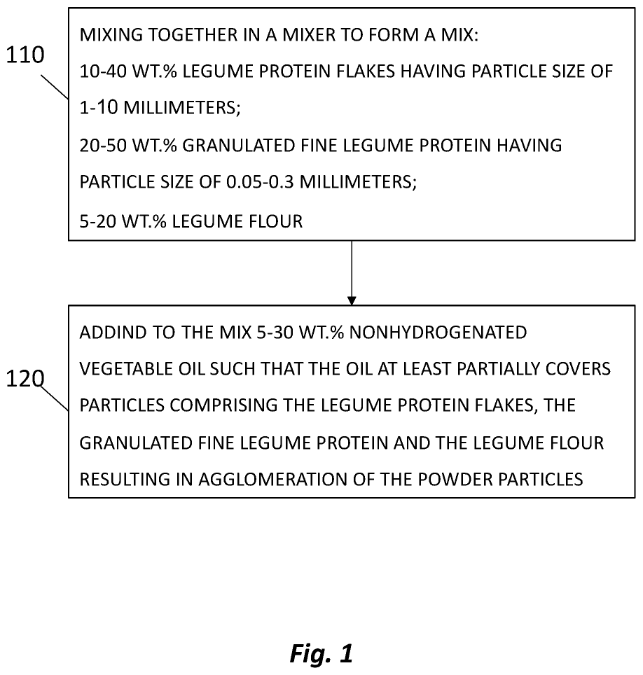

Reference is now made for FIG. 1 which is a flowchart of a method of making vegan analog granulated powder, according to some embodiments of the invention. In step 110, embodiments of the method may include mixing together in a mixer to form a mix:

10-50 wt.% legume protein flakes having particle size of 1-10 millimeters; 10-50 wt.% granulated fine legume protein having particle size of 0.05-0.3 millimeters; and 5-20 wt.% legume flour (e.g., functional legume flour) having particle size of at most 300 microns. In some embodiments, the mixer may be any mixer, manual mixer, mechanical mixer, pneumatic mixer and the like.

In some embodiments, several different legume proteins and different legume flours may be mixed. For example, the source for the protein flakes and/or the granulated fine legume protein may include: pea protein, chickpeas protein, beans protein, soybeans protein, lentils protein, lupins protein, and a combination thereof In some embodiments, the source for legume flour may be chickpeas flour, beans flour, soybeans flour, pea flour, lentil flour, lupins flour, and a combination thereof

In some embodiments, additives such as fibers and flavors, disclosed herein above, may be added to the mix during mixing. For example, fried onion, yeast extract, cocoa, caramel, salt, BBQ flavor, beef/pork/lamb/chicken/fish flavor and/or umami flavor may be added and mixed with the mix.

In step 120, embodiments of the method may include adding to the mix 1.5-25 wt.% nonhydrogenated vegetable oil such that the oil at least partially covers particles comprising the legume protein flakes, the granulated fine legume protein and the legume flour resulting in agglomeration of the powder particles. In some embodiments, the oil may be added during the mixing of the legume mix, using any know method. For example, the oil may be manually/automatically sprayed on the mix, coated by fluid bed coating machine, coated by a coating tumble drum. In some embodiments, the oil may be added for 5 min to 3 hours depends on the adding method and the amount of mix.

### EXAMPLES

Example 1—preparing instant beef analog granulated powder

An instant beef analog granulated powder was prepared using manual mixing for mixing the powders and manual spray bottle for adding the nonhydrogenated vegetable oil. Table 1 summarizes the composition of the final product.

TABLE 1

| Component | Amount wt. % |
|---|---|
| Pea protein flakes | 18-22 |
| Granulated fine pea protein | 30-35 |
| Functional pea flour | 10-15 |
| Nonhydrogenated canola oil | 15-20 |
| Fibers | 7 |
| Beat concentrate | 0.8 |
| Fried onion | 5-6 |
| Beef flavor | 0.2 |
| BBQ flavor | 1 |
| Umami flavor | 0.5 |
| Cacao | 1 |
| salt | 1.2 |

Example 2—preparing instant chicken analog granulated powder

An instant chicken analog granulated powder was prepared using manual mixing for mixing the mix and manual spray bottle for adding the nonhydrogenated vegetable oil. Table 2 summarizes the composition of the final product.

TABLE 2

| Component | Amount wt. % |
|---|---|
| Pea protein flakes | 18-22 |
| Granulated fine pea protein | 30-35 |
| Functional pea flour | 10-15 |
| Nonhydrogenated canola oil | 15-20 |
| Fried onion | 5-6 |
| Fibers | 7 |
| Umami flavor | 0.5 |
| Chicken flavor | 0.3 |
| salt | 1.2 |

Both instant analog granulated powders were mixed with water (e.g., tap water) at room temperature to produce, a vegan mixture having minced meet texture. Both instant analog granulated powders are stabilizers free, do not contain any hydrogenated oil and nonallergenic.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An instant vegan meat analog granulated powder comprising:
10-50 wt.% legume protein flakes having particle size of 1-10 millimeters;
10-50 wt.% granulated fine legume protein having particle size of 0.05-0.3 millimeters;
5-20 wt.% legume flour having a particle size of at most 300 microns; and
1.5-25 wt.% nonhydrogenated vegetable oil,
wherein the granulated powder comprises coated particles, such that each of the coated particles comprises a mixture of dry ingredients and a coating of vegetable oil at least partially covering the dry ingredients, and
wherein the dry ingredients comprise the legume protein flakes, the granulated fine legume protein, and the legume flour.

2. The instant vegan meat analog granulated powder of claim 1, wherein the legume flour is functional legume flour.

3. The instant vegan meat analog granulated powder of claim 1, further comprising 3-15% edible fibers.

4. The instant vegan meat analog granulated powder of claim 1, wherein the coated particles have a particle size of 2-20 millimeter.

5. The instant vegan meat analog granulated powder of claim 1, wherein the legume is pea.

6. The instant vegan meat analog granulated powder of claim 1, wherein the legume is selected from chickpeas, beans, soybeans, pea, lentil, lupins, and a combination thereof.

7. The instant vegan meat analog granulated powder of claim 1, further comprising additives.

8. The instant vegan meat analog granulated powder of claim 7, wherein the additives are selected from taste additives and color pigments.

9. The instant vegan meat analog granulated powder of claim 7, wherein the granulated powder is for beef analog and the additives are one or more of: beat concentrate, fried onion, yeast extract, cocoa, caramel, salt, BBQ flavor, beef and umami flavors.

10. The instant vegan meat analog granulated powder of claim 7, wherein the granulated powder is for pork analog and the additives are one or more of: fried onion, yeast extract, cocoa, caramel, salt, BBQ flavor, pork flavor and umami flavors.

11. The instant vegan meat analog granulated powder of claim 7, wherein the granulated powder is for lamb analog and the additives are one or more of: beat concentrate, fried onion, yeast extract, cocoa, caramel, salt, BBQ flavor, lamb flavor and umami flavors.

12. The instant vegan meat analog granulated powder according to claim 7, wherein the granulated powder is for chicken analog and the additives are one or more of:
chicken flavor, fried onion, yeast extract, umami flavor and salt.

13. The instant vegan meat analog granulated powder according to claim 7, wherein the granulated powder is for fish analog and the additives are one or more of:
fish flavor, fried onion, yeast extract, umami flavor and salt.

14. A vegan beef analog comprising, 40-60 wt.% water and the vegan analog granulated powder of claim 9.

15. A vegan pork analog comprising, 40-60 wt.% water and the vegan analog granulated powder of claim 10.

16. A vegan lamb analog comprising, 40-60 wt.% water and the vegan analog granulated powder of claim 11.

17. A vegan chicken analog comprising, 40-60 wt.% water and the vegan analog granulated powder of claim 12.

18. A vegan fish analog comprising, 40-60 wt.% water and the vegan analog granulated powder of claim 13.

19. A method of making a dry vegan meat analog granulated powder comprising:
mixing together in a mixer to form a dry mix:
10-50 wt.% legume protein flakes having particle size of 1-10 millimeters;
10-50 wt.% granulated fine legume protein having particle size of 0.05-0.3 millimeters; and
5-20 wt.% legume flour having a particle size of at most 300 microns; and
adding to the dry mix 1.5-25 wt.% nonhydrogenated vegetable oil, while mixing, such that the oil at least partially coats particles, such that each coated particle comprises the legume protein flakes, the granulated fine legume protein, the legume flour, and a vegetable oil coating resulting in agglomeration of the powder particles.

20. The method of claim 19, wherein adding the oil is conducted by one of:
manual spray bottle, a fluid bed coating machine, spray coating machine and a coating tumble drum.
